(19) United States
(12) Patent Application Publication
(10) Pub. No.: US 2021/0334153 A1
(43) Pub. Date: Oct. 28, 2021

(54) REMOTE ERROR DETECTION METHOD ADAPTED FOR A REMOTE COMPUTER DEVICE TO DETECT ERRORS THAT OCCUR IN A SERVICE COMPUTER DEVICE

(71) Applicant: Jabil Circuit (Shanghai) Co., Ltd., Shanghai (CN)

(72) Inventors: Yen-Cheng Chang, New Taipei (TW); Chin Liang, New Taipei (TW)

(73) Assignee: Jabil Circuit (Shanghai) Co., Ltd., Shanghai (CN)

(21) Appl. No.: 17/233,853

(22) Filed: Apr. 19, 2021

(30) Foreign Application Priority Data
Apr. 24, 2020 (CN) 202010332224.8

(51) Int. Cl. G06F 11/07

(52) U.S. Cl. CPC G06F 11/0772; G06F 11/0709; G06F 11/0787; G06F 11/0778; G06F 11/0754

(57) ABSTRACT

A remote error detection method is provided. A service computer stores error log collection (ELC) data that are related to the service computer device, and generates and transmits an alert signal to a remote computer device when a baseboard management controller (BMC) thereof determines that a predetermined trigger event has occurred. The remote computer device receives the error log collection data after the service computer device sends the alert signal to the remote computer device.

### CROSS-REFERENCE TO RELATED APPLICATION

This application claims priority of Chinese Invention Patent Application No. 202010332224.8, filed on Apr. 24, 2020.

### TECHNICAL FIELD

The disclosure relates to an error detection method, and more particularly to a remote error detection method for an engineer to remotely detect errors of a computer device.

### BACKGROUND

With the development of network technology, the need for data centers with large numbers of service hosts that provide various network services arises. In practice, such a data center may have more than one hundred service hosts. A conventional error detection method is to set various trigger events in advance through the baseboard management controllers (BMCs) of the service hosts in the data center, with the trigger events being, for example, abnormally low fan speed, termination of fan operation, shutting down of service host, excessively high temperature sensed by various temperature sensors, etc. When any of these trigger events occurs, the corresponding BMC will send an alert message to a remote host, such as another service host or a computer host, through a network connection. That is, when one of the service hosts in the data center has an abnormal execution, an engineer in front of the remote host can be informed by the alert message, and then visit the data center physically to perform debugging on the service host that corresponds to the alert message. However, the existing error detection method can only achieve the effect of notification, while the engineer may not be informed of what kind of error has occurred; also, it is inconvenient for the engineer to locate the service host that has the abnormal execution from among a large number of service hosts.

### SUMMARY

Therefore, an object of the disclosure is to provide a remote error detection method that enables an engineer to debug remotely.

According to the disclosure, the remote error detection method is adapted for a remote computer device to detect errors that occur in a service computer device. The service computer device includes a baseboard management controller (BMC) and a storage unit. The method includes steps of: A) by the service computer device, storing error log collection data that are related to the service computer device in the storage unit; B) by the service computer device, generating an alert signal when the BMC determines that a predetermined trigger event has occurred, and transmitting the alert signal to the remote computer device; and C) by the remote computer device, receiving the error log collection data that are stored in the storage unit after the service computer device sends the alert signal to the remote computer device.

### BRIEF DESCRIPTION OF THE DRAWINGS

Other features and advantages of the disclosure will become apparent in the following detailed description of the embodiment(s) with reference to the accompanying drawings, of which:

FIG. 1 is a block diagram illustrating a service computer device and a remote computer device that are used to implement embodiments of a remote error detection method according to the disclosure;

FIG. 2 is a flow chart illustrating steps of a first embodiment of the remote error detection method according to the disclosure; and

FIG. 3 is a flow chart illustrating steps of a third embodiment of the remote error detection method according to the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

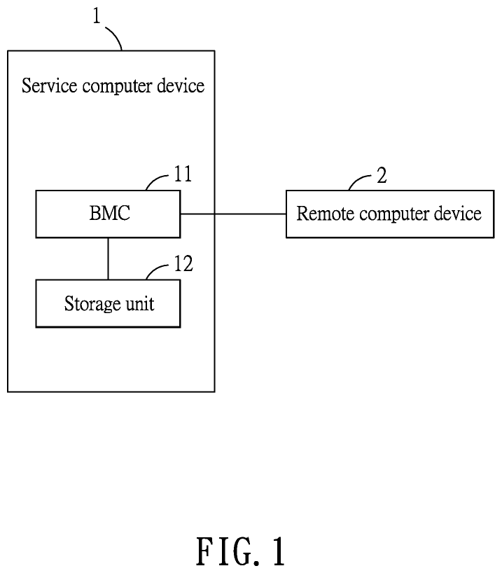

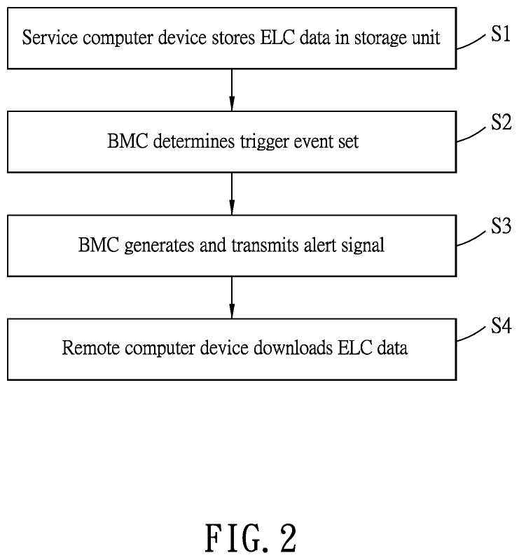

Referring to FIGS. 1 and 2, a first embodiment of a remote error detection method for a remote computer device 2 (also called remote host computer) to detect errors that occur in a service computer device 1 (also called service host computer) according to this disclosure is provided. The service computer device 1 may be one of a plurality of servers that are placed in a data center, and includes a baseboard management controller (BMC) 11 and a storage unit 12 that corresponds to and is electrically connected to the BMC 11. The storage unit 12 may include, for example but not limited to, one or more of flash memory, hard drive disks, solid state drives, etc., and is accessible by the BMC 11. The remote computer device 2 is communicatively connected to the BMC 11 of the service computer device 1.

The first embodiment includes steps S1 to S4.

In step S1, a central processing unit (CPU, not shown) and/or the BMC 11 of the service computer device 1 generates error log collection (ELC) data that are related to the service computer device 1 during operation thereof (e.g., execution of various tasks, programs, etc.), and stores the ELC data in the storage unit 12. The ELC data may include, for example but not limited to, at least one of output data of an intelligent platform management interface (IPMI) protocol, a boot log of a basic input/output system (BIOS), a runtime log of an embedded system, or internal log data of the BMC 11.

For example, the output data of the IPMI protocol may include, for example but not limited to, “channel_cipher_ipmi”, “channel_cipher_sol”, “channel_info”, “chassis_status”, “firewall_info”, “fru”, “mc_getenables”, “mc_guid”, “mc_info”, “mc_wdt”, “pef_info”, “pef_list”, “sdr_elist”, “sdr_info”, “sel_elist”, “sel_info”, “sensors”, “session_active”, “sol_info”, “user_list”, “user_summary”, etc., which can be used by engineers to learn a status of the service computer device 1. The boot log of the BIOS may include, for example but not limited to, “SOLHostCapture”, “SOLHostCapture.log.1”, etc., which can be used by engineers to analyze error messages, and a root cause and a consequence of relevant errors that are generated during a boot process of the BIOS. The runtime log of the embedded system may include, for example but not limited to, “rt_cpuinfo”, “rt_filesystems”, “rt_ifconfig”, “rt_interrupts”, “rt_iomem”, “rt_locks”, “rt_meminfo”, “rt_mtd”, “rt_pagetypeinfo”, “rt_postcode”, “rt_ps”, “rt_top”, “rt_vmallocinfo”, “rt_vmstat”, “rt_zoneinfo”, etc., which can be used by engineers to learn a status of the BMC 11, so the engineers can know whether the occurrence of errors or abnormalities result from an internal system of the BMC 11. The internal log data of the BMC 11 may be related to records of webpage browsing, and/or editing history of remote log-in authorization, etc.

In step S2, prior to error detection, the remote computer device 2 sends a trigger event setting to the service computer device 1, and the service computer device 1 selects a portion (e.g., one or more or all) of candidate trigger events that are pre-stored in the storage unit 12 according to the trigger event setting, so as to form a trigger event set that includes the selected portion of the candidate trigger events. The candidate trigger events are related to various abnormal operations of the service computer device 1, such as abnormally low fan speed, termination of fan operation, shutting down of service computer device 1, excessively high temperature sensed by various temperature sensors, etc., but this disclosure is not limited in this respect. Any trigger event in the trigger event set is referred to as a predetermined trigger event.

In step S3, upon determining that a predetermined trigger event has occurred, the BMC 11 generates and transmits an alert signal to the remote computer device 2. In some embodiments, the alert signal indicates the predetermined trigger event or otherwise corresponds to the predetermined trigger event, so that the remote computer device 2 is notified of occurrence of the predetermined trigger event. For example, the selected portion of the candidate trigger events includes termination of fan operation, so upon determining that one of the fans of the service computer device 1 has stopped operating, the BMC 11 generates and transmits the alert signal that indicates occurrence of termination of fan operation to the remote computer device 2. The alert signal may be a notification message related to, for example but not limited to, “Broadcast Rsyslog”, “Pre-config IP Rsyslog”, “Redfish Notification” or “IPMI SEL trap”, etc., but this disclosure is not limited in this respect.

In step S4, upon receipt of the alert signal, the remote computer device 2 automatically downloads the ELC data that are stored in the storage unit 12 via the BMC 11. It is noted that, in this embodiment, regardless of whether the predetermined trigger event occurs or not, errors that occur during operation of the CPU and/or the BMC 11 of the service computer device 1 will be continuously collected and recorded in the ELC data, so the ELC data include complete error data that are related to the service computer device 1. Accordingly, when the remote computer device 2 receives the alert signal, the ELC data downloaded by the remote computer device 2 would include all of the error data. The data transmission of the ELC data between the remote computer device 2 and the BMC 11 may be related to, for example but not limited to, “TFTP server”, “Redfish oem schema”, “SFTP”, or “IPMI oem command”, etc., but this disclosure is not limited in this respect.

A second embodiment of the remote error detection method according to this disclosure is similar to the first embodiment, and differs therefrom in that, in the second embodiment, step S2 is omitted, that is, the trigger event set is not determined by the remote computer device 2 sending the trigger event setting to the service computer device 1, but may be predefined in the service computer device 1. For example, an engineer may directly operate the service computer device 1 to select a portion of the candidate trigger events to create the trigger event set.

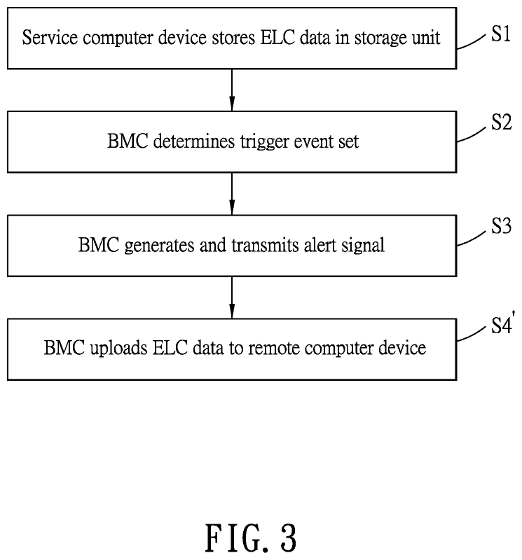

Referring to FIGS. 1 and 3, a third embodiment of the remote error detection method according to this disclosure is similar to the first embodiment, and differs therefrom in that step S4 of the first embodiment is replaced by step S4′, where the BMC 11 of the service computer device 1 automatically uploads the error log collection data that are stored in the storage unit 12 to the remote computer device 2. In one implementation, the remote computer device 2 sends a feedback signal to the service computer device 1 upon receipt of the alert signal, and the BMC 11 of the service computer device 1 automatically uploads the error log collection data that are stored in the storage unit 12 to the remote computer device 2 upon receipt of the feedback signal. In one implementation, the BMC 11 of the service computer device 1 automatically uploads the error log collection data that are stored in the storage unit 12 to the remote computer device 2 when transmitting the alert signal to the remote computer device 2.

A fourth embodiment of the remote error detection method according to this disclosure is similar to the third embodiment, and differs therefrom in that, in the third embodiment, step S2 is omitted, that is, the trigger event set is not determined by the remote computer device 2 sending the trigger event setting to the service computer device 1, but may be predefined in the service computer device 1. For example, an engineer may directly operate the service computer device 1 to select a portion of the candidate trigger events to create the trigger event set.

In summary, in the embodiments of the remote error detection method according to this disclosure, error information of the service computer device 1 is continuously collected and stored as the ELC data, and, upon determining that the predetermined trigger event has occurred, the BMC 11 generates the alert signal to notify the remote computer device 2 of occurrence of the predetermined trigger event, making the remote computer device 2 automatically acquire the ELC data that are stored in the storage unit 12. As a result, the engineer would become aware of and fix the errors that occurred on the service computer device 1 remotely, and thus would not be required to physically visit the data center at which the service computer device 1 is located in order to fix the errors.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A remote error detection method adapted for a remote computer device to detect errors that occur in a service computer device, the service computer device including a baseboard management controller (BMC) and a storage unit, said method comprising steps of:
A) by the service computer device, storing error log collection data that are related to the service computer device in the storage unit;
B) by the service computer device, generating an alert signal when the BMC determines that a predetermined trigger event has occurred, and transmitting the alert signal to the remote computer device; and
C) by the remote computer device, receiving the error log collection data that are stored in the storage unit after the service computer device has sent the alert signal to the remote computer device.

2. The remote error detection method of claim 1, wherein, in step A), the error log collection data include at least one of output data of an intelligent platform management interface (IPMI) protocol, a boot log of a basic input/output system (BIOS), a runtime log of an embedded system, or an internal log data of the BMC.

3. The remote error detection method of claim 2, wherein, in step B), the predetermined trigger event is related to abnormal operation of the service computer device.

4. The remote error detection method of claim 3, wherein, in step B), the alert signal corresponds to the predetermined trigger event, so that the remote computer device is notified of occurrence of the predetermined trigger event.

5. The remote error detection method of claim 4, further comprising, between step A) and step B), a step of: D) by the remote computer device, sending a trigger event setting to the service computer device, so that the service computer device selects a portion of candidate trigger events that are pre-stored in the storage unit to form a trigger event set according to the trigger event setting, the predetermined trigger event being included in the selected portion of the candidate trigger events;
wherein, in step C), the remote computer device automatically downloads the error log collection data that are stored in the storage unit via the BMC upon receipt of the alert signal.

6. The remote error detection method of claim 5, wherein, in step B), the alert signal is a notification message related to one of Broadcast Rsyslog, Pre-config IP Rsyslog, Redfish Notification and IPMI SEL trap.

7. The remote error detection method of claim 4, wherein, in step B), the predetermined trigger event is one of candidate trigger events that are pre-stored in the storage unit; and
wherein, in step C), the remote computer device automatically downloads the error log collection data that are stored in the storage unit via the BMC upon receipt of the alert signal.

8. The remote error detection method of claim 7, wherein, in step B), the alert signal is a notification message related to one of Broadcast Rsyslog, Pre-config IP Rsyslog, Redfish Notification and IPMI SEL trap.

9. The remote error detection method of claim 7, wherein the transmission of the error log collection data in step C) is related to one of TFTP server, Redfish oem schema, SFTP and IPMI oem command.

10. The remote error detection method of claim 4, further comprising, between step A) and step B), a step of: D) by the remote computer device, sending a trigger event setting to the service computer device, so that the service computer device selects a portion of candidate trigger events that are pre-stored in the storage unit to establish a trigger event set according to the trigger event setting, the predetermined trigger event being included in the selected portion of the candidate trigger events;
wherein, in step C), the BMC of the service computer device automatically uploads the error log collection data that are stored in the storage unit to the remote computer device.

11. The remote error detection method of claim 10, wherein the transmission of the error log collection data in step C) is related to one of TFTP server, Redfish oem schema, SFTP and IPMI oem command.

12. The remote error detection method of claim 4, further comprising, between step A) and step B), a step of: D) by the remote computer device, sending a trigger event setting to the service computer device, so that the service computer device selects a portion of candidate trigger events that are pre-stored in the storage unit to establish a trigger event set according to the trigger event setting, the predetermined trigger event being included the selected portion of the candidate trigger events;
wherein, in step C), the remote computer device sends a feedback signal to the service computer device upon receipt of the alert signal, and the BMC of the service computer device automatically uploads the error log collection data that are stored in the storage unit to the remote computer device upon receipt of the feedback signal.

13. The remote error detection method of claim 12, wherein the transmission of the error log collection data in step C) is related to one of TFTP server, Redfish oem schema, SFTP and IPMI oem command.

14. The remote error detection method of claim 4, wherein, in step B), the predetermined trigger event is one of candidate trigger events that are pre-stored in the storage unit; and
wherein, in step C), the BMC of the service computer device automatically uploads the error log collection data that are stored in the storage unit to the remote computer device.

15. The remote error detection method of claim 14, wherein the transmission of the error log collection data in step C) is related to one of TFTP server, Redfish oem schema, SFTP and IPMI oem command.

16. The remote error detection method of claim 4, wherein, in step B), the predetermined trigger event is one of candidate trigger events that are pre-stored in the storage unit; and
wherein, in step C), the remote computer device sends a feedback signal to the service computer device upon receipt of the alert signal, and the BMC of the service computer device automatically uploads the error log collection data that are stored in the storage unit to the remote computer device upon receipt of the feedback signal.

17. The remote error detection method of claim 16, wherein the transmission of the error log collection data in step C) is related to one of TFTP server, Redfish oem schema, SFTP and IPMI oem command.
